(19) United States
(12) Patent Application Publication
(10) Pub. No.: US 2005/0249214 A1
(43) Pub. Date: Nov. 10, 2005

(54) System and process for managing network traffic

(76) Inventor: Tao Peng, North Melbourne (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/841,381

(22) Filed: May 7, 2004

(51) Int. Cl. H04L 12/28

(52) U.S. Cl. 370/392

(57) ABSTRACT

A traffic management system for use in a communications network, including a detection module for determining the source addresses of received network packets, and for comparing the source addresses with stored source address data for network packets received in a previous time period. The system monitors increases in the number of new source IP addresses of received packets to detect a network traffic anomaly such as a distributed denial of service (DDoS) attack or a flash crowd. If a traffic anomaly is detected, a filtering module performs history-based filtering to block a received packet unless one or more legitimate packets with the same source address have been previously received in a predetermined time period.

### FIELD OF THE INVENTION

The present invention relates to a system and process for managing network traffic, and in particular for detecting changes in network traffic patterns which may be indicative of a distributed denial of service attack or a flash crowd event, and for filtering network traffic in response to such changes.

### BACKGROUND

A Denial of service (DoS) attack is a malicious attempt to cripple an online service in a communications network such as the Internet. The most common form of DoS attack is a bandwidth attack wherein a large volume of useless network traffic is directed to one or more network nodes, with the aim of consuming the resources of the attacked nodes and/or consuming the bandwidth of the network in which the attacked nodes reside. The effect of such an attack is that the attacked nodes appear to deny service to legitimate network traffic, and are effectively shut down, either partially or completely.

A Distributed Denial of Service (DDoS) attack is a form of DoS attack in which the attack traffic is launched from multiple distributed sources. There are two common forms of DDoS attacks, which are referred to herein as the typical DDoS attack and the distributed reflector denial of service (DRDoS) attack, and collectively as Highly Distributed Denial of Service (HDDoS) attacks. As shown in FIG. 1, a typical DDoS attack has two stages. The first stage is to compromise vulnerable systems 102 available in the network and install attack tools on these compromised systems 102. This is referred to as turning the computers 102 into “zombies”. In the second stage, the attacker 100 sends an attack command to the zombies 102 through a secure channel 104 to launch a bandwidth attack against the victim(s) 106. The attack traffic is then sent from the “zombies” 102 to the victim(s) 106. The attack traffic can use genuine or spoofed (i.e., faked) source Internet protocol (IP) addresses. However, there are two major motivations for the attacker 100 to use randomly spoofed IP addresses: (i) to hide the identity of the “zombies” 102 and reduce the risk of being traced back via the “zombies” 102; and (ii) to make it difficult or impossible to filter the attack traffic without disturbing legitimate network traffic addressed to the victim(s) 106.

As shown in FIG. 2, a distributed reflector denial of service (DRDoS) attack uses third-party systems (e.g., routers or web servers) 202 to bounce the attack traffic to the victim 106. The DRDoS attack is effected in three stages. The first stage is the same as the first stage of the typical DDoS attack described above. However, in the second stage, instead of instructing the “zombies” 102 to send attack traffic to the victims 106 directly, the “zombies” 102 are instructed to send spoofed traffic with the victim's IP address as the source IP address to the third parties 202. In a third stage, the third parties 202 then send reply traffic to the victim 106, thus constituting a DDoS attack. This type of attack shut down www.grc.com, a security research website, in January 2002, and is considered to be a potent, increasingly prevalent and worrisome Internet attack. The DRDoS attack is more dangerous than the typical DDoS attack for the following reasons. First, the DRDoS attack traffic is further diluted by the third parties 202, which makes the attack traffic even more distributed. Second, the DRDoS attack has the ability to amplify the attack traffic, which makes the attack even more potent.

Sophisticated tools to gain root access to other people's computers are freely available on the Internet. These tools are easy to use, even for unskilled users. Once a computer is cracked, it is turned into a “zombie” under the control of one “master”. The master is operated by the attacker, and can instruct all its zombies to send bogus data to one particular destination. The resulting traffic can clog links, and cause routers near the victim or the victim itself to fail under the load.

At present, there are no effective means of detecting bandwidths attacks for the following reasons. Both IP and TCP can be misused as dangerous weapons quite easily. Since all Web traffic is TCP/IP based, attackers can release their malicious packets on the Internet without being conspicuous or easily traceable. It is the sheer volume of all packets that poses a threat rather than the characteristics of individual packets. A bandwidth attack solution is, therefore, more complex than a straightforward filter in a router.

One difficulty in responding to bandwidth attacks is attack detection. Detection of a bandwidth attack might be relatively easy in the vicinity of the victim, but becomes more difficult as the distance (i.e., the hop count) to the victim increases if the attack traffic is spread across multiple network links, making it more diffuse and harder to detect, since the attack traffic from each source may be small compared to the normal background traffic. Existing solutions to bandwidth attacks become less effective when the attack traffic becomes distributed. A further challenge is to detect the bandwidth attack as soon as possible without raising a false alarm, so that the victim has more time to take action against the attacker.

Previously proposed approaches rely on monitoring the volume of traffic that is received by the victim. A major drawback of these approaches is that they do not provide a way to differentiate DDoS attacks from “flash crowd” events, where many legitimate users attempt to access one particular site at the same time. Due to the inherently bursty nature of Internet traffic, a sudden increase of traffic can be mistaken for an attack. If the response is delayed in order to ensure that the traffic increase is not just a transient burst, this risks allowing the victim to be overwhelmed by a real attack. Moreover, some persistent increases in traffic may not be attacks, but actually “flash crowd” events. Clearly, there is a need for a better approach to detecting bandwidth attacks. There is also a need for rapidly detecting and responding to a flash crowd event.

A further difficulty in responding to DDoS attacks is that it is very difficult to distinguish between normal traffic and attack traffic. Existing rate-limiting methods punish the good traffic as well as the bad traffic.

It is desired to provide a system and process for managing traffic in a communications network, a process for detecting anomalous traffic, and a filtering process that alleviate one or more of the above difficulties, or at least provide a useful alternative.

### SUMMARY OF THE INVENTION

In accordance with the present invention, there is provided a process for managing traffic in a communications network, including:
determining the source address of a received network packet; and
comparing said source address with stored source address data for network packets received in a previous time period.

The present invention also provides a process for managing traffic in a communications network, including:
determining the source addresses of received network packets;
comparing said source address with stored source address data for network packets received in a previous time period to determine a number of new source addresses; and
detecting a surge in network traffic on the basis of the number of new source addresses.

The present invention also provides a process for detecting anomalous traffic in a communications network, including:
determining source addresses of received network packets;
comparing said source addresses with stored source address data for network packets received in a previous time period to determine the number of new source addresses for which data is not included in said stored source address data; and
detecting at least one of a distributed denial of service attack and a flash crowd event on the basis of the number of new source addresses.

The present invention also provides a filtering process, including:
determining the source address of a received network packet;
determining at least one of the number of packets with said source address received in a previous time period and a fraction of said previous time period in which packets with said source address were received; and
determining whether to block said received network packet on the basis of at least one of said number and said fraction.

The present invention also provides a traffic management system for use in a communications network, including:
a source address detection module for determining the source addresses of received network packets; and
a decision module for detecting a surge in network traffic on the basis of a comparison of said source addresses with stored source address data for network packets received in a previous time period.

### BRIEF DESCRIPTION OF THE DRAWINGS

Preferred embodiments of the present invention are hereinafter described, by way of example only, with reference to the accompanying drawings, wherein:

FIG. 1 is schematic diagram of a typical distributed denial of service attack on a network node;

FIG. 2 is schematic diagram of a distributed reflector denial of service (DRDoS) attack on a network node;

FIG. 3 is a block diagram of a first preferred embodiment of a network traffic management system;

FIG. 4 is a block diagram of a second preferred embodiment of a network traffic management system;

FIG. 5 is a flow diagram of a traffic management process executed by the system;

FIG. 6 is a flow diagram of an offline learning process of the traffic management process;

FIG. 7 is a flow diagram of an address data collection process of the traffic management process;

FIG. 8 is a flow diagram of a flow rate detection process of the traffic management process;

FIG. 9 is a flow diagram of a new address detection process of the traffic management process;

FIG. 10 is a flow diagram of a decision process of the traffic management process;

FIG. 11 is a flow diagram of a filtering process executed by the system;

FIG. 12 is a schematic diagram of a hash table generated by the system;

FIG. 13 is a schematic diagram of indexing using a Bloom filter;

FIGS. 14 to 16 are graphs of cumulative sequences generated from the numbers of new source addresses as a function of time slot;

FIG. 17 is a graph of the volume of network traffic as a function of time over a time period including a DDoS attack;

FIGS. 18 is a graph of the number of new source addresses as a function of time over the same time period as for FIG. 17;

FIGS. 19 to 21 are graphs of the fraction of new source addresses as a function of time for the Auck-IV-in, Auck-IV-out, and Bell-I traces, respectively;

FIGS. 22 to 24 are graphs of cumulative sum values yₙ corresponding to FIGS. 19 to 21, respectively;

FIGS. 25 to 27 are graphs of cumulative sum values yₙ for a first-mile router using the Auck-IV-out trace for DDoS attacks having 10, 4, and 2 new source addresses, respectively;

FIGS. 28 to 30 are graphs of cumulative sum values yₙ for a last-mile router using the Auck-IV-in trace for DDoS attacks having 200, 40, and 18 new source addresses, respectively;

FIG. 31 is a graph of the fraction of new source addresses as a function of time for the 2000 DARPA Intrusion Detection dataset;

FIG. 32 is a graph of the filtering accuracy as a function of date for filtering based on Rule 1: source addresses that have been received over the past d days, for d=1, 2, and 3 days;

FIG. 33 is a graph of the filtering accuracy as a function of date for filtering based on Rule 1 combined with Rule 2: source addresses from which at least u packets have been received over the past d days, for u=4 to 9, d=2 days; and

FIG. 34 is a graph of the filtering accuracy as a function of the size of the filtering table of the system.

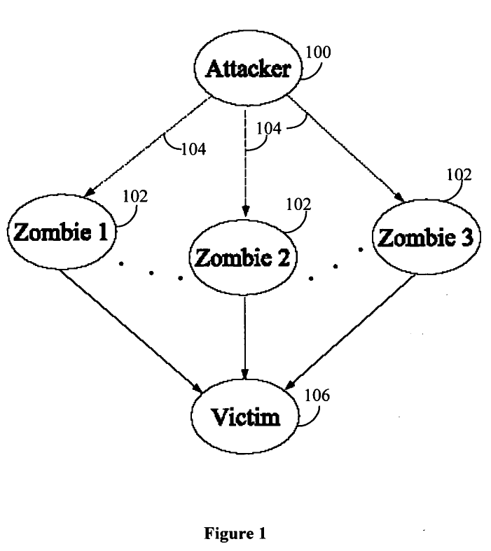

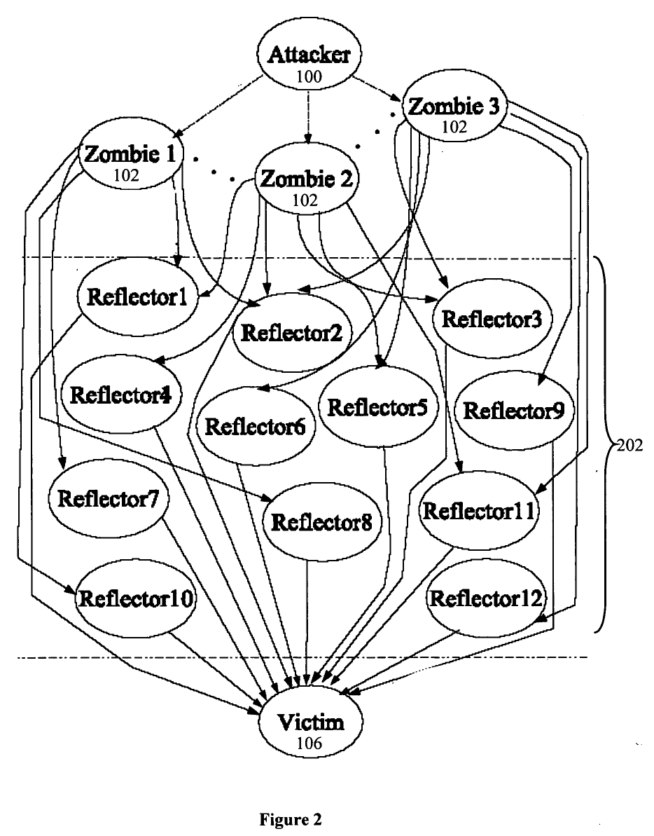

### DETAILED DESCRIPTION OF THE PREFERRED EMBODIMENTS

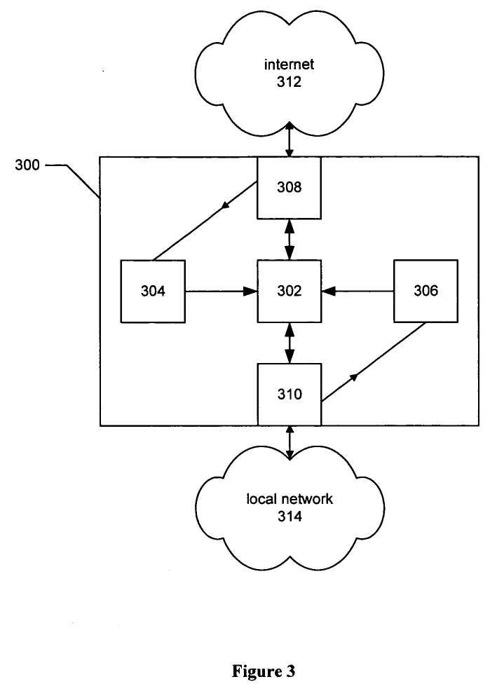

As shown in FIG. 3, a network traffic management system 300 includes a router 302 and two source IP address monitoring (SIM) modules 304, 306 respectively connected to first and second network interfaces 308, 310 of the system 300. The network interfaces 308, 310 are respectively connected to first and second communications network 312, 314.

Typically, the traffic management system 300 is connected between an untrusted public network such as the Internet and a protected and possibly trusted local network which may include publicly accessible servers within a demilitarised zone (DMZ). Accordingly, the first network 312 is hereinafter referred to as the Internet 312, and the second network 314 is hereinafter referred to as the local network 314. The first interface 308 is thus referred to as the inbound interface 308, and the second interface 310 is referred to as the outbound interface 310. As shown by the arrows in FIG. 3, one SIM 304 processes inbound traffic from the Internet 312 and is therefore referred to as the inbound SIM 304, and the other SIM 306 processes outbound traffic from the local network 314 and is therefore referred to as the outbound SIM 306. The inbound and outbound SIMS 304, 306 operate independently of one another.

Notwithstanding the above, it should be understood that the traffic management system 300 can be used at many alternative locations within a network topology, and is not restricted to the particular arrangement described herein.

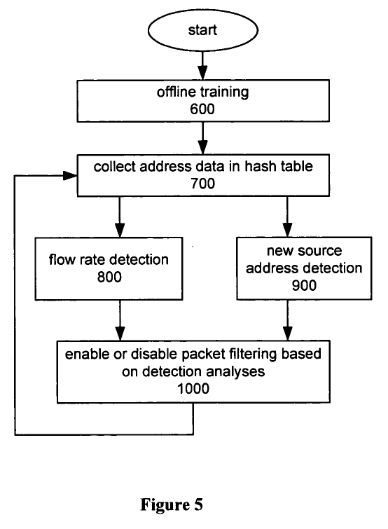

The traffic management system 300 executes a traffic management process, as shown in FIG. 5, that manages network traffic addressed to one or more network nodes. In particular, the traffic management process uses stored network address data to detect changes in network traffic which may be indicative of an imminent surge in the volume of network traffic resulting from a flash crowd event or a DDoS attack, and upon detecting such a change, to perform history-based filtering on network traffic. In the case of a DDoS attack, the history-based filtering blocks attack traffic while forwarding legitimate network traffic, as described below. Although the system 300 is predominantly described in terms of detecting and responding to DDoS attacks, it should be understood that the processes described herein are equally applicable to detecting and responding to any event that gives rise to changes in traffic patterns as described below. Typically, these changes are indicative of a (possibly imminent) surge of network traffic directed to one or more network sites.

In particular, the traffic management process detects the two forms of DDoS attack described above and referred to collectively as Highly Distributed Denial of Service (HDDoS) attacks. However, simpler attacks, such as attacks from one or a small number of sources are also detected. In this specification, DRDoS attack detection refers to detection of attack traffic from the reflectors to the victim, which is the third stage of a DRDoS attack, as described above.

The traffic management system 300 is preferably placed so that the router 302 provides Internet 312 access to a node (hereinafter referred to as the victim) of the local network 314 for which traffic is being managed and that is being protected from DoS attacks. In this arrangement, the router 302 is referred to herein as the edge router 302. For packets leaving the local network 314, the edge router 302 is their first-mile router. Conversely, the edge router 302 is a last-mile router for incoming packets directed to the local network 314. The first-mile SIM 306 plays a primary role in detecting a flooding attack originating in the local network 314, due mainly to its proximity to the sources of the flooding attack. However, its detection sensitivity may decline with the increase of the size of the attack group; in a large-scale DDoS attack, the flooding sources can be orchestrated so that individual attack traffic flows cause only an insignificant deviation from normal traffic patterns. In contrast, the last-mile SIM 304 can quickly detect attacks as the flooding traffic is aggregated. As described below, filtering can be triggered to protect the victim. To bring down the victim under protection, the flooding sources have to significantly increase their flooding rates. However, this increased flooding traffic makes it easier to detect the flooding attack and its sources at first-mile routers.

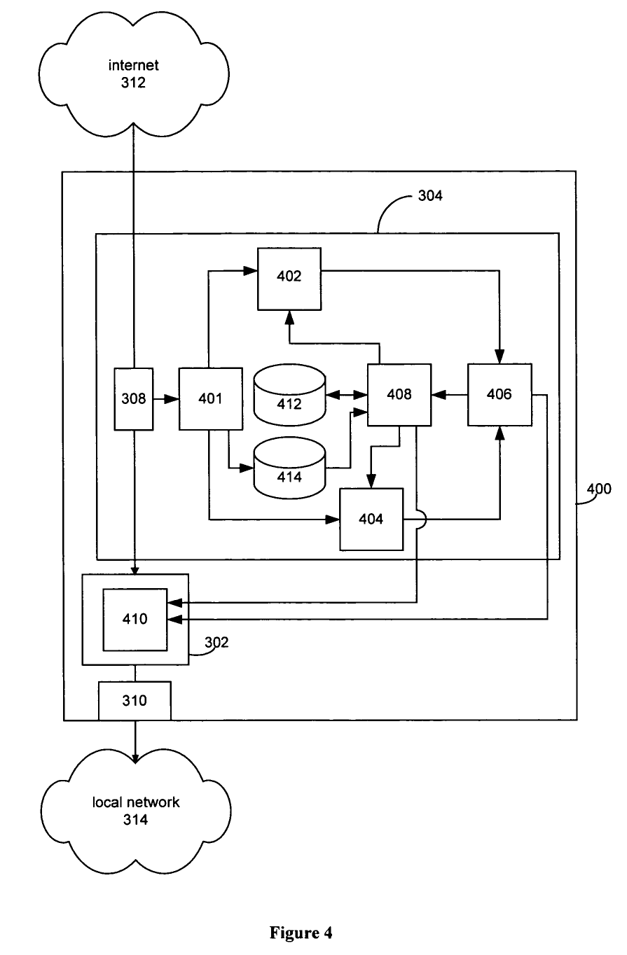

Although it is preferred that the system 300 include the two SIM modules 304, 306, if the local network 314 is trusted, the SIM 306 that processes outbound traffic can be omitted if desired. For simplicity, the processes executed by the traffic management system 300 are described below with reference to inbound traffic processing by the SIM 304 only, and a second preferred embodiment 400 that omits the second SIM 306, as shown in FIG. 4. However, it should be understood that the description below applies equally to the processing of outbound traffic by the outbound SIM 306 of the first preferred embodiment 300.

As shown in FIG. 4, the SIM 304 includes traffic management components or modules 401 to 408, including a packet collector 401, a flow rate detection engine 402, a new address detection engine 404, a decision module 406, and a learning engine 408. The router 302 includes a filtering engine 410. The SIM 304 also includes an address database 412, and a packet database 414.

In the described embodiments, the traffic management systems 300, 400 are standard computer systems such as Intel IA-32 or IA-64 based computer systems executing a Linux operating system, and the traffic management processes are implemented as software modules compiled into the Linux kernel, being the traffic management modules 401 to 410. The databases 412 and 414 are standard structured query language (SQL) databases. However, it will be apparent to those skilled in the art that the components of the traffic management systems 300, 400 can be distributed over a variety of alternate locations, and that at least parts of the traffic management process can alternatively be implemented by dedicated hardware components, such as application-specific integrated circuits (ASICs). In particular, it is envisaged that the traffic management modules 402 to 410 of the traffic management systems 300, 400 can be provided as hardware components in a router.

Although the traffic management process is represented as a linear process in the flow diagram of FIG. 5, some steps of the traffic management process are simultaneously executed by different components of the system 400. In particular, the offline training process 600 is executed at regular intervals that can be set by an administrator, but is executed once per 24 hours by default. This interval is referred to as the update interval. The other steps 700 to 1000 of the process are executed continually. However, the offline training process 600 processes data generated by the address data collection process 700, and hence the latter process 700 will be described first.

The address data collection process 700 generates several statistics for incoming traffic for successive time intervals or slots Δn of equal length. The choice of time slot length is a compromise between making the time slots short so that the detection engines 402, 404 can quickly detect an attack, and making the time slots long to reduce the load on the detection engines 402, 404. By default, the system 400 uses a 10 second time slot; however this can be changed by an administrator.

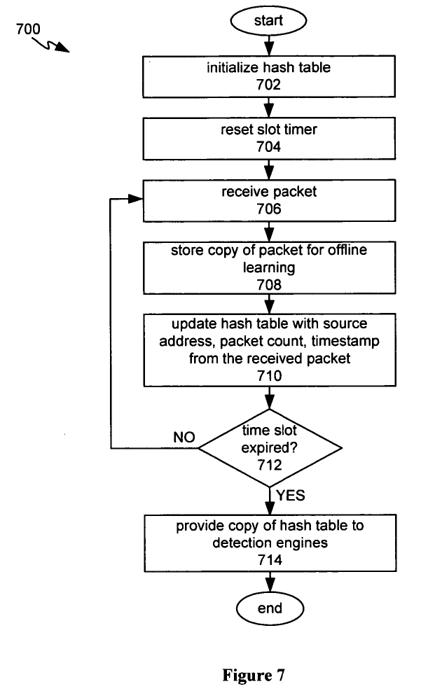

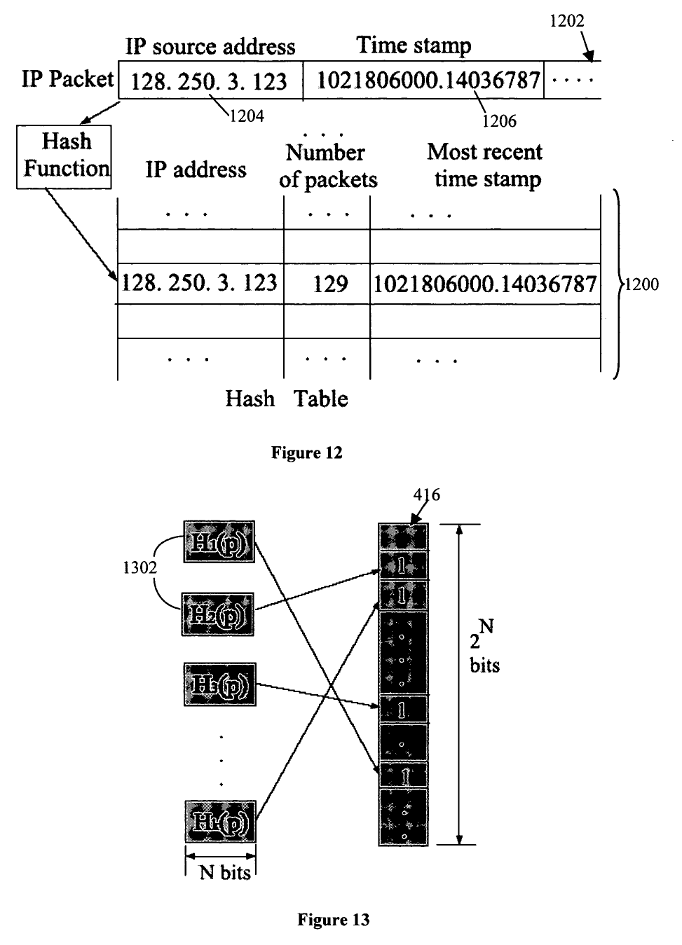

As shown in FIGS. 7 and 12, the address data collection process 700 begins by initializing a hash table 1200 at step 702, and resetting a slot timer at step 704. At step 706, the packet collector 401 receives copies of inbound network packets through a passive (read-only) interface in promiscuous mode which is not assigned an IP address. This makes the packet collector 401, detection engines 402, 404, decision module 406 and learning engine 408 immune to attacks since they are invisible to an attacker.

At step 708, a copy of the packet header is stored in the packet database 414 for offline learning, as described below. As shown in FIG. 12, each packet header 1202 includes a source IP address 1204 and a timestamp 1206. At step 710, the hash table 1200 is updated by storing the source IP address 1204 (if the address 1204 is not already stored in the hash table 1200), incrementing the total number of packets with that source address 1204 received since the hash table 1200 was initialised, and replacing any stored timestamp for that address with the timestamp 1206 from the packet header 1202. At step 712, if the slot timer has not expired, the process 700 loops back to receive the next packet at step 706. Otherwise, a copy of the hash table 1200 is provided to the detection engines 402, 404, and the address data collection process 700 ends.

The packet headers stored in the packet database 414 at step 708 of the address data collection process 700 are processed by the offline training process 600 to update the address database 412 when the offline training process 600 is executed once per 24 hours (or other update interval, as set by the administrator). The address database 412 stores address data for network packets received by the system 400 over a previous time period referred to as the history period. The history period can be set by a system administrator, but has a default value of one month.

The address database 412 provides a series of database records. Each record includes a source IP address of one or more network packets received by the system 400 during one update interval, the total number of packets with that source address received by the system 400 between updates, and a timestamp representing the most recent time that a packet with that source address was received during the interval.

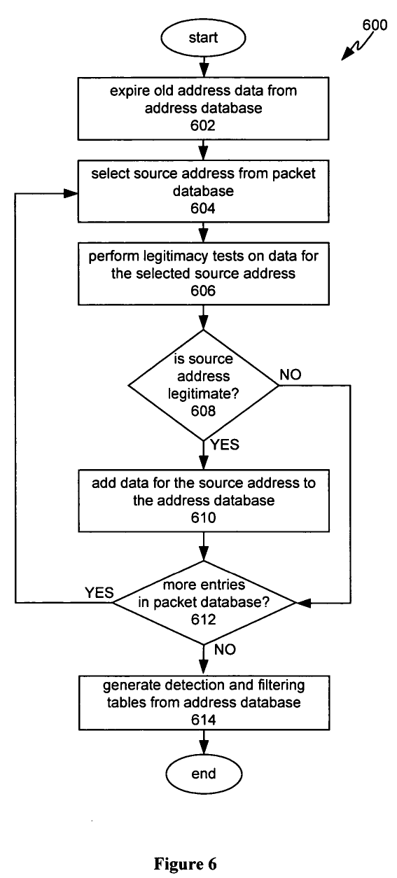

As shown in FIG. 6, the offline training process 600 begins by expiring old addresses from the address database 412 at step 602. That is, the learning engine 408 generates a current timestamp representing the current date and time, and determines the difference between the current timestamp and the timestamp stored in each record of the address database 412. If the record is older than the history period (in this case, one month), it is deleted from the address database 412. Otherwise, the next record is retrieved. This process is repeated for every record in the address database 412 to ensure that it represents only the source addresses of packets received in the past month (or other history period as configured by the administrator).

The learning engine 408 then selects a source address from a packet header stored in the packet database 414 at step 604. At step 606, legitimacy tests are applied to all of the data packet headers having that source address in the packet database 414 to determine whether the source address is legitimate. An IP address is considered to be legitimate if the received network packets with that address appear to be part of a genuine flow, as opposed to bogus packets having, for example, a spoofed source address or generated by a port scan. For example, a TCP connection with fewer than three packets in the packet database 414 is considered to be an abnormal IP flow and is not added to the address database 412. Additional legitimacy tests can be applied to the packet database 414 as desired. The legitimacy tests ensure that the address data in the address database 412 does not include address data representing any bandwidth attacks. At step 608, if the packet data for the selected source address is considered to be legitimate, at step 610 a new record is added to the address database 412, including the source address, the number of packets with that address received in the past update interval, and the timestamp of the most recently received packet with that source address. At step 612, if there are more unprocessed packet headers in the packet database 414, then the process loops back to select the next source address at step 604. Processed database records are deleted from the packet database 414. Alternatively, the entire packet database 414 can be deleted at the end of the process 600 if the address data collection process 700 is configured to create a new packet database once every update interval so it can store packet headers in the new packet database, while the offline training process 600 processes packet headers stored in the packet database for the previous update interval.

At step 614, the learning engine 408 generates two hash tables from the address database 412. One hash table is used for detection purposes, and is referred to as the detection table. The other hash table is used for history-based filtering, and is referred to as the filtering table. These two hash tables are generated using a Bloom filter, as described in Burton H. Bloom, Space/Time Tradeoffs In Hash Coding With Allowable Errors, in Communications of the ACM, 13(7):422-426, July 1970. Each of the hash tables is used to determine whether a given source IP address is a member of a list of source IP addresses ‘stored’ in the hash table, as follows. As shown in FIG. 13, the Bloom filter generates k distinct IP address digests 1302 for each source IP address using independent uniform hash functions, and uses the N-bit results to index into the hash table, which is a 2^{N}-sized bit array 1304. The array 1304 is initialized to all zeros, and bits are set to one as packets are source addresses are ‘stored’ in the array. Membership tests are conducted by generating the k digests 1302 for the source IP address of a received network packet and checking the indicated bit positions. If any one of them is zero, the source address was not stored in the array 1304. The Bloom filter provides an extremely efficient means for indexing into the detection table and the filtering table.

The detection table is generated by ‘storing’ in the table each unique source address in the address database 412, as described above. Thus the detection table provides an efficient means for determining whether a given source address is included within the address database 412. The filtering table is generated in a similar manner, but a source address is only stored in the filtering table if the address passes one or more rules currently in effect to determine whether a source address is considered to be “frequent”, as described below. Thus the filtering table provides an efficient means for determining whether a given source address is a “frequent” address, as described below.

Detection of a DDoS Attack

Returning to FIG. 5, after the address data collection process 700 has accumulated address data over one time slot, this address data is sent to the two detection engines 402, 404 for processing.

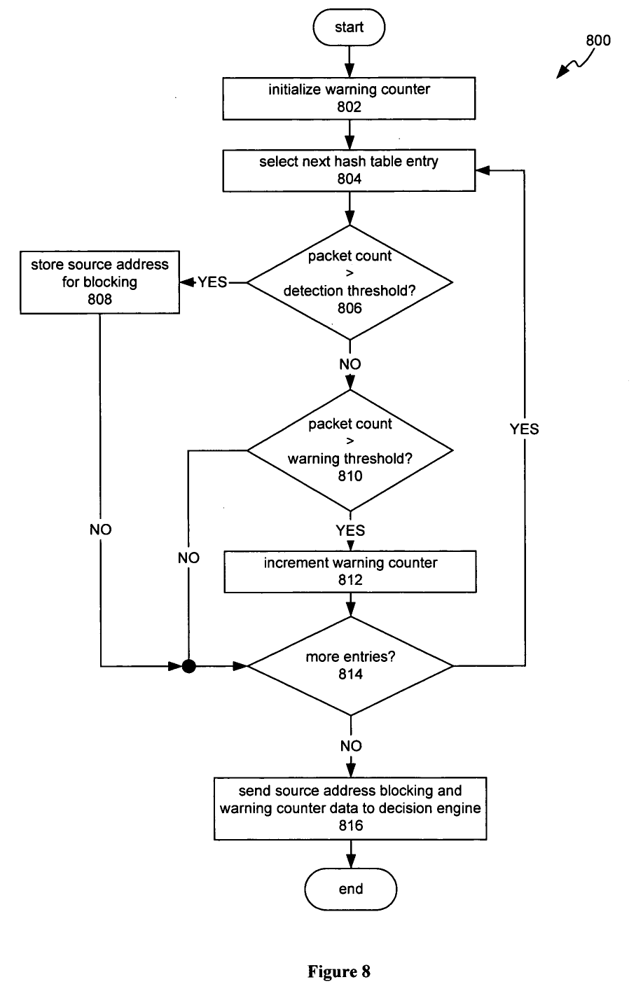

The flow rate detection module 402 executes a flow rate detection process 800, as shown in FIG. 8. The process begins by initialising a warning counter at step 802. At step 804, a hash table entry is selected from the hash table generated by the address data collection process 700. The flow rate detection engine 402 compares the packet count value from the hash table, representing the number of packets with the source address of the selected hash table entry that were received in the previous time slot. The packet count is compared with two threshold values: a warning threshold, and a detection threshold. If, at step 806, it is determined that the packet count exceeds the detection threshold, then this indicates an excessive flow rate for that source address, which may indicate a bandwidth attack. Consequently, at step 808, the source address is stored so that the filtering engine 410 can block packets from that source address. Otherwise, at step 810, if it is determined that the packet count exceeds the warning threshold, then at step 812 the warning counter is incremented in order to determine the number of source addresses whose packet flows are high, but not sufficiently high to warrant blocking on an individual basis. At step 814, if there are more entries in the hash table, then the process loops back to select the next hash table entry at step 804. Otherwise, the stored source addresses and warning counter data are sent to the decision engine 406. This completes the flow rate detection process.

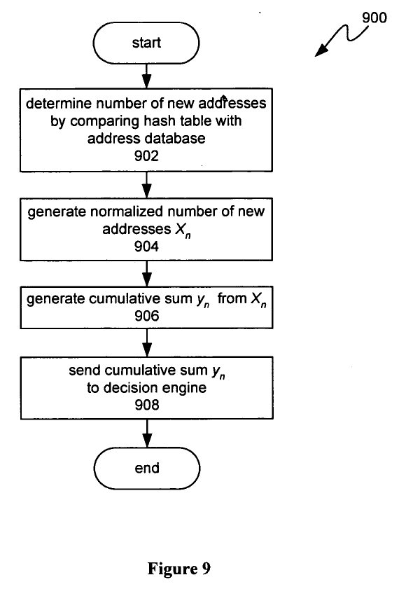

The new source address detection module 404 executes a new source address detection process 900, as shown in FIG. 9, that monitors received source IP addresses to detect changes or anomalies in traffic patterns which may be indicative of flash crowd events or Highly Distributed Denial of Service (HDDoS) attacks. The new source address detection process takes advantage of the huge number of new IP addresses in attack traffic to the victim. The new source address detection process can detect attacks close to their sources in the early stages of an attack.

As described above, each hash table entry includes a source IP address, the number of IP packets, and the timestamp of the most recent packet for that IP address. At step 902, the new source address detection engine 402 determines the number of new source IP addresses that have not previously been seen in the history period by comparing the hash table for the current time slot with the contents of the detection table. Any IP addresses that are stored in the hash table but are not stored in the detection table are considered to be new source IP addresses. By analyzing the number of new source IP addresses in successive time slots, as described below, a (possibly imminent) traffic surge such as a flash crowd event or a HDDoS attack can be detected by the new address detection engine 404.

In order to detect a traffic surge, the new address detection engine 404 detects changes in the number of new IP addresses over time. However, this number is a random variable due to the stochastic nature of Internet traffic. The simplest way to do this is to use the technique of fixed-size batch detection to monitor the change of the mean value at every time interval. However, as described above, it is desirable to detect a bandwidth attack as soon as possible without raising a false alarm. Consequently, the new address detection engine 404 uses a sequential change-point detection process to detect meaningful increases in the number of new source addresses.

Let Tₙ represent the set of unique IP addresses in the hash table and Dₙ represent the unique IP addresses stored in the detection table. |Tₙ−Tₙ∩Dₙ| thus represents the number of new IP addresses in Δₙ, and can be used to detect a traffic surge. However, |Tₙ−Tₙ∩Dₙ| is dependent upon the position (referred to as the network traffic monitoring point) of the traffic management system 300, 400 in the network topology, and also upon the length of each time slot Δₙ. To remove these dependencies, the normalized variable

$${X}_{n} = \frac{\vert {T}_{n} - {T}_{n} ⋂ {D}_{n} \vert}{{T}_{n}}$$

is generated at step 906, and this variable is monitored instead.

The values of Xₙ generated at step 904 are monitored using a cumulative sum (CUSUM) method, as described in M. Basseville and I. V. Nikiforov. Detection of Abrupt Changes: Theory and Application. Prentice Hall, 1993 (“Basseville” ), and B. E. Brodsky and B. S. Darkhovsky. Nonparametric Methods in Change-point Problems. Kluwer Academic Publishers, 1993 (“Brodsky”).

There are two key measures that are used to evaluate bandwidth attack detection systems. The first is the false alarm rate, which is one of the biggest concerns among the anomaly detection community. If a system produces too many false alarms, it will require lots of time to investigate whether the alarms indicate a real attack or not. If an attack response (such as packet filtering) is based on a false alarm, innocent traffic will be unfairly punished, and normal network services will be disturbed. The second measure is the detection time. One of the advantages of a bandwidth detection system is that it can detect the attack as soon as possible so that appropriate responses can be initiated earlier to minimize or eliminate the damage caused by the attack. Unfortunately, these two parameters are in conflict, as it is difficult to shorten the detection time while simultaneously reducing the false alarm rate. Therefore, a tradeoff must be made between these two. The CUSUM method used by the traffic management system 400 is said to be optimal in minimizing the detection time while simultaneously reducing the false alarm rate, as described in Basseville, in Brodsky, and also in H. Wang, D. Zhang, and K. G. Shin, Detecting SYN flooding attacks, in Proceedings of IEEE Infocom '2002, June 2002.

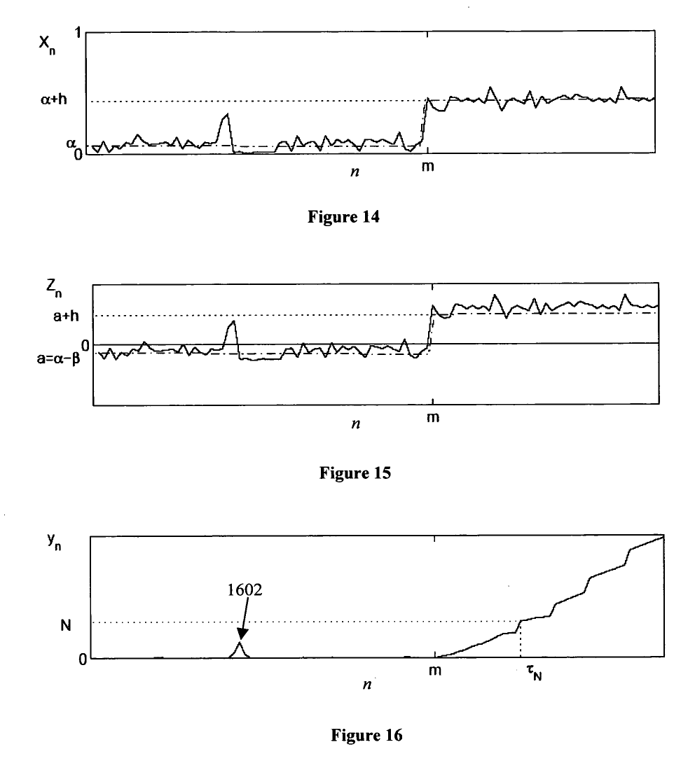

Returning to FIG. 9, at step 906, a cumulative sum yₙ of the Xₙ values is generated after each time slot, according to:
yₙ=(yₙ₋₁+Xₙ−β)⁺≡(yₙ₋₁+Zₙ)⁺≡max(yₙ₋₁+Zₙ, 0),
with Zₙ≡(Xₙ−β) and y₀=0. β is a parameter that is chosen to avoid the value of yₙ increasing without limit due to the number of new IP addresses in each time slot, which has some expectation value E(Xₙ)=α>0. For example, FIG. 14 is a graph of Nₙ as a function of timeslot number, where a DDoS attack appears at timeslot m. Prior to the onset of this attack, the values of Xₙ fluctuate around the value α. Note that 0<α<<1 under normal conditions because there is usually only a small proportion of source IP addresses that are new to the network. Moreover, β is chosen with β>α so that on average, and in the absence of attack, the value Xₙ−β will be a negative value: E(Xₙ−β)≡E(Zₙ)=a<0, and as negative values do not accumulate over time, yₙ will normally be 0. For example, FIG. 15 is a graph of Zₙ as a function of timeslot number generated from the dataset shown in FIG. 14. Prior to the onset of the attack at time slot m, the values of Zₙ now fluctuate around a value a=α−β. FIG. 16 is a graph of the corresponding yₙ as a function of timeslot number n. In the absence of attack, the values yₙ are mostly 0, with occasional short runs of small positive values (such as the peak 1602 in FIG. 16) appearing due to the stochastic nature of network traffic. However, these runs will be short lived due to the cumulative sum unless the value of Xₙ increases from its average value α by a value >−a=(β−α) over a sustained period so that E(Zₙ)>0. In the example shown in FIGS. 14 to 16, this begins at timeslot m. Because the CUSUM method detects changes based on the cumulative effect of the changes made in a random sequence instead of using a single threshold to check every value, the performance of attack detection is not affected by whether the attack rate is bursty or constant.

Returning to FIG. 9, the cumulative sum value yₙ generated at step 906 is sent to the decision engine 406 at step 908. This completes the new address detection process 900.

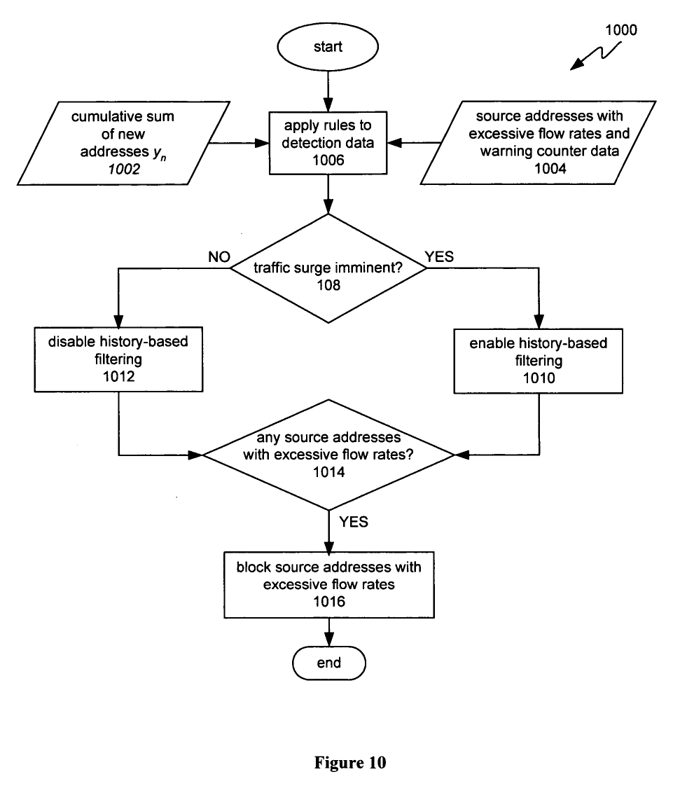

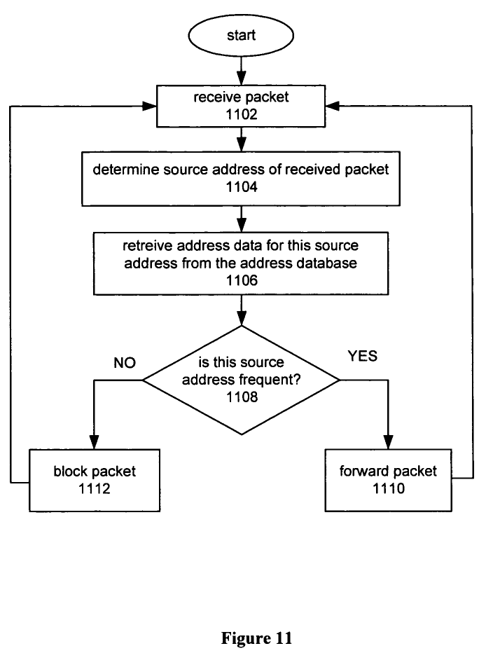

Returning to FIG. 5, the results of the flow rate detection process 800 and the new address detection process 900 are processed by a decision process 1000, as shown in FIG. 10, executed by the decision engine 406. At step 1006, the decision engine 406 applies rules to the cumulative sum value yₙ 1002 and the flow rate data 1004 to determine an appropriate response. Specifically, the decision engine 406 compares the cumulative sum value yₙ 1002 with two threshold values G_{w} and N, with G_{w} slightly below N, to determine whether the number of new source addresses is: (i) suspicious, or is indicative of (ii) normal network traffic, or (iii) abnormal network traffic, i.e., a traffic surge such as a flash crowd or a DDoS attack. If yₙ<G_{w}, the new address state is considered to be normal; if yₙ>N, the new address state is considered to be abnormal, and if G_{w}<yₙ<N, then the new address state is considered to be suspicious. The values of G_{w} and N are set by an administrator.

Similarly, the flow rate data 1004 is used to define a flow rate state as one of three possible states. If any flows exceeded the flow rate threshold in this time slot, then the flow rate state is considered abnormal. Alternatively, if no source addresses exceeded the detection threshold but the number of flows exceeding the warning threshold exceeds an administrator-configurable threshold value T_{w}, then the flow rate state is considered suspicious. Otherwise, the flow rate state is considered to be normal.

At step 108, the decision engine 406 applies the following table to the three possible states for the flow rate state and the new address state, to determine whether a surge in network traffic (or a possible DDoS attack, as indicated in Table 1) is imminent:

TABLE 1

| New Address | | |
|---|---|---|
| Detection Engine | Flow Rate Detection Engine | Decision Engine |
| normal | normal | NORMAL |
| normal | suspicious | NORMAL |
| suspicious | normal | NORMAL |
| suspicious | suspicious | ATTACK |
| attack | any output | ATTACK |
| any output | attack | ATTACK |

If a traffic surge or attack is imminent or underway, then the decision engine 406 instructs the filtering engine 410 to enable history-based filtering, as described below. Otherwise, the decision engine 406 instructs the filtering engine 410 to disable history-based filtering.

In order to reduce or avoid false positives, positive values of yₙ are not considered to constitute an attack unless the value of yₙ exceeds a value N, as described above. However, as shown in FIG. 16, this delays the detection time from a time m when yₙ exceeds zero to a later time τ_{N}. A normalized detection delay time ρ_{N} can be defined as follows:

$${ρ}_{N} = \frac{{( {τ}_{N} - m )}^{+}}{N}$$

In general, a value h can be defined as the minimum increase of the mean value required in order to detect an attack. As described in Brodsky, it can be shown that the limit of the normalized detection delay time ρ_{N} is a value γ that is related to the lower bound h of actual increase during an attack as follows:

$${ρ}_{N} -> γ = \frac{1}{h - \vert a \vert}$$

where h−|a| is the lower bound of the mean of {Zₙ} when an attack occurs. Since the actual increase during an attack will usually be larger than h, the above equation provides a conservative estimate of the normalized detection time, the actual detection time should be shorter.

The two design goals of low false alarm rate and short detection time can be achieved by choosing optimal values for the two parameters β and N. β is the offset value used to ensure that the values of {Zₙ} will have a negative mean value a, as shown in FIG. 15. The larger β is chosen, the less likely a positive value will appear in {Zₙ}. Therefore, it is less likely that the test statistics y_{N} will be accumulated to a large value to indicate an attack. N is the attack threshold for y_{N}. The larger the N, the lower the false alarm rate, but the longer the detection time.

According to the equations above, N can be determined from a and h. Moreover, β=α+|a|. Thus, if a (the mean of {Zₙ} during normal operation) and h (the lower bound of the actual increase during an attack) are given, then β and N will also be decided.

Given the lack of a parametric model for {Zₙ}, it is difficult to determine optimal choices for β and h in the general case. However, it has been shown that the asymptotical optimal is achieved by the CUSUM method when h=2a in one of its worst cases, a Gaussian random sequence, as described in Brodsky. Accordingly, the traffic management system 400 also uses this choice by default.

Based on values for a and h, the system 400 determines β, the upper bound of Xₙ, and the detection threshold N, as follows. First, the equation above is used to determine γ from a and h. This is used as an approximation of the normalized detection delay time ρ_{N}. Next, given a required detection time (τ_{N}−m), which can be approximated by the product of N and γ, we can obtain N from the equation above. For a given network traffic monitoring point, E(Xₙ)=α is observed under normal conditions. Hence, β can be determined by β=α+|a|.

When attack traffic converges at a “last-mile” router (i.e., close to the victim), there is a large increase in the percentage of new source IP addresses during an attack, which can be easily observed with h>>α. In other words, the change in the value of Zₙ caused by the attack traffic will be large. Therefore, the system uses the values |a|=0.05 and h=0.1 when the SIM 304 is processing inbound traffic at the last-mile router. For the last-mile router, the false alarm rate is low because of the aggregated attack traffic behavior. Consequently, the detection time is more important and this should be as short as possible. Thus, the minimum possible detection time is set to be τ_{N}=m+1. If this value is combined with |a|=0.05 and h=0.1 in the equations above, then

$${ρ}_{N} -> γ = \frac{1}{h - \vert a \vert} = \frac{1}{0.1 - 0.05} = 20$$

$$and$$

$$N = \frac{{( {τ}_{N} - m )}^{+}}{{ρ}_{N}} = \frac{( m + 1 - m )}{20} = 0.05 .$$

In contrast, the attack traffic at a “first-mile” router (i.e., close to the attack source) is much more diluted. This is because sophisticated attackers can generate attack traffic from multiple sources so that the attack sources do not standout from the background traffic; i.e., the change value h contributed by the attack traffic will be small. In order to find a balance between detection sensitivity and false alarm rate, the values |a|=0.01 and h=0.02 are used in the outbound SIM 306 in the embodiment 300 of FIG. 3 for processing outbound traffic at the first-mile router. For the first-mile router, the most challenging task is to reduce the false positive rate because of the sparse attack traffic. Thus, the system uses τ_{N}=m+3, which results in γ=100 and N=0.03. These derived values satisfy the requirements for an asymptotical optimal CUSUM method. However, all these values can be adjusted by an administrator to suit local network conditions if desired.

Filtering During a DDoS Attack

Thus far, the use of the stored address data to detect a DDoS attack (or other network traffic anomaly) has been described. However, the filtering table derived from the address database 412 is used by the filtering engine 410 to determine whether to forward or block a received packet during a DDoS attack (or other network traffic anomaly).

When the decision engine 408 instructs the filtering engine 410 to enable filtering, the filtering engine 410 executes a history-based filtering process, as shown in FIG. 10. The process begins when a packet is received at step 1102. The source address of the received packet is determined at step 1104. Assuming for the purposes of description that the filtering engine 410 has not been configured to block packets received from that source address, then at step 1106, a lookup of the filtering table is performed to determine whether the source address is stored in the filtering table. If, at step 1108, the source address is stored in the filtering table, then it is considered to be “frequent”, as described below, and the packet is forwarded at step 1110. Otherwise, the packet is blocked at step 1112.

Traffic with one source IP address is considered to define one IP flow. Let Sᵢ={s₁ⁱ,s₂ⁱ,s₃ⁱ,s₄ⁱ, . . . , sₙ_{ᵢ}ⁱ} denote the collection of all the legitimate IP addresses that appeared in the network on date i, where |Sᵢ|=nᵢ. Let F^{k}={f₁,f₂,f₃,f₄, . . . , fₘ}denote the collection of all the frequent legitimate IP addresses from date 1 to date k, where |F^{k}|=m .

When the learning engine 408 generates the filtering table at step 614 of the offline training process 600, two rules are used to determine whether a packet is considered to be “frequent”. Let A={a₁,a₂,a₃,a₄, . . . , aₓ} denote the source IP addresses appearing in a distributed denial of service attack. Since there is a stable group of IP addresses that visit the network regularly, and DDoS attacks use randomly spoofed IP addresses, the following relationship holds for k days' traffic observation:

$$\vert {S}_{1} ⋃ {S}_{2} … ⋃ {S}_{k} \vert < {\sum }_{i = 1}^{k} {n}_{i} \vert A \vert$$

It will be apparent that F^{k}⊂(S₁∪S₂ . . . ∪Sₖ). A statistical method is used to determine a threshold to determine the frequent user collection F based on the source IP address distribution within (S₁∪S₂ . . . ∪Sₖ). Thus,

$${P}_{normal} = \frac{\vert F ⋂ {S}_{j} \vert}{\vert {S}_{j} \vert}$$

represents the percentage of normal IP flows admitted on date j (j>k) and

$${P}_{ddos} = \frac{\vert F ⋂ A \vert}{\vert A \vert}$$

represents the percentage of attack IP flows admitted. Ideally, Pₙₒᵣₘₐₗ should be 1, and P_{ddos} should be 0.

Specifically, the learning engine 408 uses either or both of two rules to determine whether a given IP address is considered to be a frequent IP address. The first rule considers an IP address to be frequent based on the number of the days it appeared within the history period. Let p₁(d) represent the collection of unique IP addresses that each appeared in at least d days. Let f₁(d) represent the percentage of good traffic getting through when using p₁(d) as the filtering table.

The second rule is the number of packets per source IP address. Let p₂(u) represent the collection of unique source IP addresses that have at least u packets. Let f₂(u) represent the percentage of good traffic getting through when using p₂(u) as the filtering table.

In practice, it is desired to keep |p (d)| and |p₂(u)| small to reduce the memory requirement for keeping the filtering table, and to keep f₁(d) and f₂(u) large so that legitimate traffic can be protected. Two parameters are involved: the number of days d and the number of packets per IP address u. These parameters can be tuned according to different network conditions and a more accurate and efficient filtering table can be obtained by combining these two rules as follows:
F_{c}=p₁(d)∩p₂(u)

There are two reasons to build an efficient filtering table. The first is that the filtering table can become too large to maintain if all source IP addresses are stored and are never expired. The second reason is that network components such as routers and web servers have limited power to process incoming traffic during a denial of service attack or flash crowd. Thus, a proportion of packets will be dropped anyway because of buffer overflow. Empirical observations of network traffic indicate that, amongst all the source IP addresses that appear in a network, only a small number of these appear regularly, and these addresses are considered to be frequent IP addresses. Therefore, it is desirable to keep a compact list of IP addresses with high priority to protect. By narrowing the range of IP addresses to protect, the address data lookup time can be reduced so as to achieve a high throughput rate. Consider the use of the two rules described above for selecting frequent addresses:

Rule 1 [p₁(d)] the number of days: Normally, users often surf the Internet at regular times, and repeat their network usage behavior daily. Thus, an IP address can be considered to be frequent based on the number of days it has appeared in the network. Let T₁ represent the total number of IP addresses that appeared in 27 days. Thus

$$\frac{{p}_{1} ( d )}{{T}_{1}}$$

represents the percentage of IP addresses that appeared in at least d days. Empirical observations of independent data sets indicate that typically only 40% of IP addresses appeared in at least two days is of a two-week period. Therefore, around 60% of the IP addresses appeared on only one day in the two week period. These addresses can be considered to be infrequent IP addresses as they are less likely to visit the network again. By increasing d, the number of IP addresses seen in at least d days decreases exponentially.

Rule 2 [p₂(u)] the number of packets per IP address: Generally, frequent IP addresses are expected to send a certain number of packets to the network. For example, downloading a web page generates at least 5 packets (4 packets for the TCP connection establishment and release and 1 packet for the HTTP request). Thus it appears desirable to only protect IP addresses that have sent more than 5 packets. However, the network administrator can tune u to make a different rule according to local conditions. For example, u can be set to a large value to obtain a more efficient filtering table in the case of a high volume attack or flash crowd event.

It is important to use a fast IP address lookup process, especially when |F| is large. Hence the system 400 uses a Bloom filter, as described above, to determine whether a given source address is stored in the filtering table and is therefore “frequent”. There are two fundamental performance measures for the History-based IP Filtering process:
(i) filtering accuracy: the percentage of legitimate IP addresses getting through; and
(ii) overhead: this depends on the size of the filtering table and the hash techniques employed.

The overhead should be as small as possible while keeping the filtering accuracy as large as possible. However, these are conflicting goals and cannot be simultaneously achieved. The filtering process used by the filtering engine 410 minimizes overhead while mainaining a specified filtering accuracy.

In an alternative embodiment, the number of IP addresses stored in the address database 412 and the detection and filtering tables is reduced by storing only an IP prefix instead of the complete IP address. For example, a hypothetical IP address of 111.222.33.44 can be stored as 111.222.33, which indicates that the packet should have originated from the network 111.222.33.0. This may be particularly useful if 128-bit IP v6 addresses are used. Moreover, the address database 412 can be partitioned by service type or destination IP address, with, for example, two or more address databases maintained for packets sent to respective port numbers. For example, one database can be used for web service packets sent to port 80, and another for other port numbers, with the detection and filtering tables similarly partitioned.

In yet a further alternative embodiment, the packet data accumulated in each time slot is processed and added to the address database 214, and the detection and filtering tables regenerated at the end of each time slot, rather than being processed offline at the end of each update period. However, it may be desirable that the detection and filtering parameters be made more stringent in such cases to detect and respond to attacks having a relatively slow attack rate. With this arrangement, the address databases 412 and the detection and filtering tables can be made more robust by authenticating each source address using a challenge-response method to determine whether a source address corresponds to a human user and not to an automated computer program. For example, in the case of an HTTP request, a challenge can be sent to the user in the form of an image of a randomly generated string, together with an instruction to replicate the string and send it back to the web server. This is easy for a human, but difficult for a computer. In this way, an attacker needs manual intervention to respond to the challenge, which makes an attack extremely difficult if not impossible.

Although the decision engine 408 has been described above in terms of applying thresholds based on data from two detection engines, it will be apparent that any number of detection methods could be used to detect network traffic anomalies, and that the decision engine 408 could alternatively use more sophisticated methods to determine whether a traffic anomaly is present based on statistical procedures, including correlation of the outputs of the various detection methods used.

### EXAMPLES

Detection of a DDoS Attack

To evaluate the efficacy of attack detection, the following simulation experiments were performed. Different types of DDoS attack traffic were generated and merged with normal traffic. The traffic management system 300 was then applied to detect the attacks from the merged traffic. The normal traffic traces were taken from publicly available data sets collected at different times from three different sources. The first set was gathered at the University of Auckland with an OC3 (155.52 Mbps) Internet access link, as described at http://wand.cs.waikato.ac.nz/wand/wits. The second data trace is taken from the DARPA intrusion detection data set, available from http://www.ll.mit.edu/IST, and the third data trace was taken on a 9 MBit/sec Internet Connection in Bell Labs, as described at http://pma.nlanr.net/Traces/long/bell1.html.

A summary of the data traces used in these experiments is listed in Table 2 below. In order to evaluate the effectiveness of attack detection, simulated attack traffic was added to the normal background traffic traces of Table 2. For example, a 5 minute DDoS attack with an attack rate of 160 packets/s was embedded in the Auck-IV-in trace of 19 Mar., 2001. Both the attack length and the attack rate are representative values that are commonly observed in the Internet.

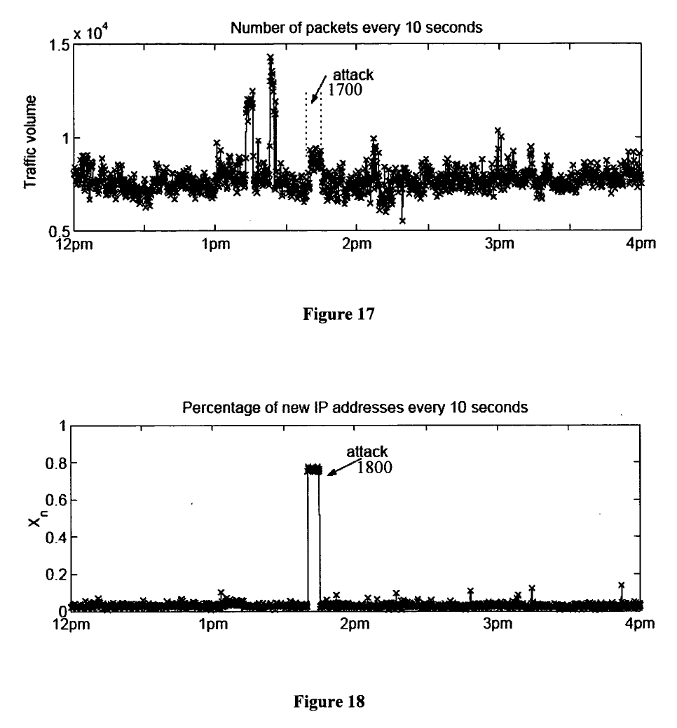

As shown in FIG. 17, it is difficult to discern any sign of the attack 1700 when analyzing the traffic based purely on traffic volume due to the bursty nature of the Internet traffic. In contrast, a large peak 1800 caused by the attack traffic is readily apparent when analyzing the percentage of new source IP addresses in the measurement interval, as shown in FIG. 18. This is because the percentage of new IP addresses stays at a very low value during normal operation. This makes the attacks detectable by the new address detection process described above, even when the attacks are highly distributed.

TABLE 2

| Trace | Trace Length | Created Time | Traffic Type |
|---|---|---|---|
| Auck-IV-in | 3 weeks | March 2001 | Uni-directional |
| Auck-IV-out | 3 weeks | March 2001 | Uni-directional |
| DARPA | 3 weeks | 1999 | Bi-directional |
| Bell-I | 1 week | May 2002 | Bi-directional |

Normal Traffic Behavior

Auck-IV-in and Auck-IV-out represent the normal traffic behavior for a medium network (OC-3 connection to the backbone Internet), while Bell-I represents normal traffic behavior for an intranet (with 100 Mbit ethernet connection to a local ISP). For evaluating the first-mile router SIM, the traffic which goes from the local network to the Internet was used as the background traffic. For evaluating the last-mile router SIM, the traffic that goes from the Internet to the local network was used as the background traffic.

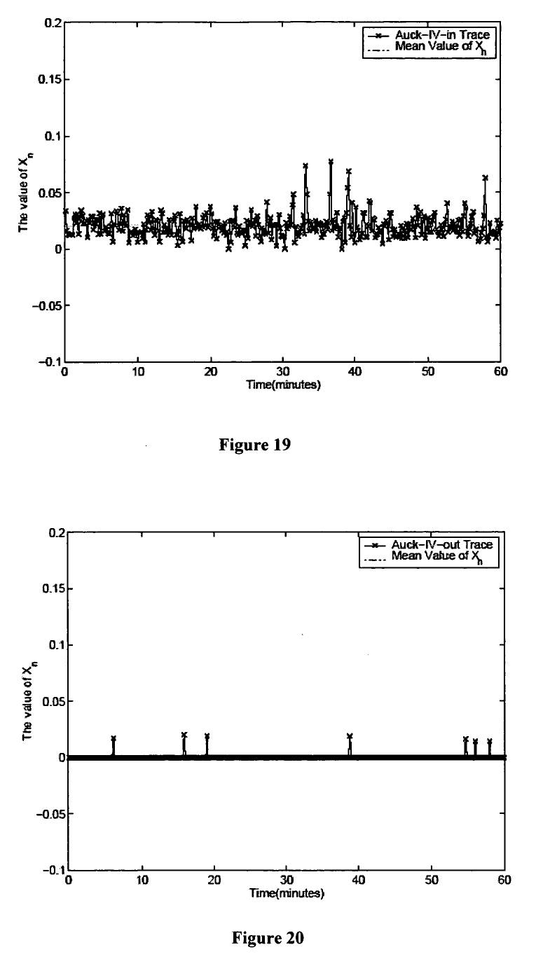

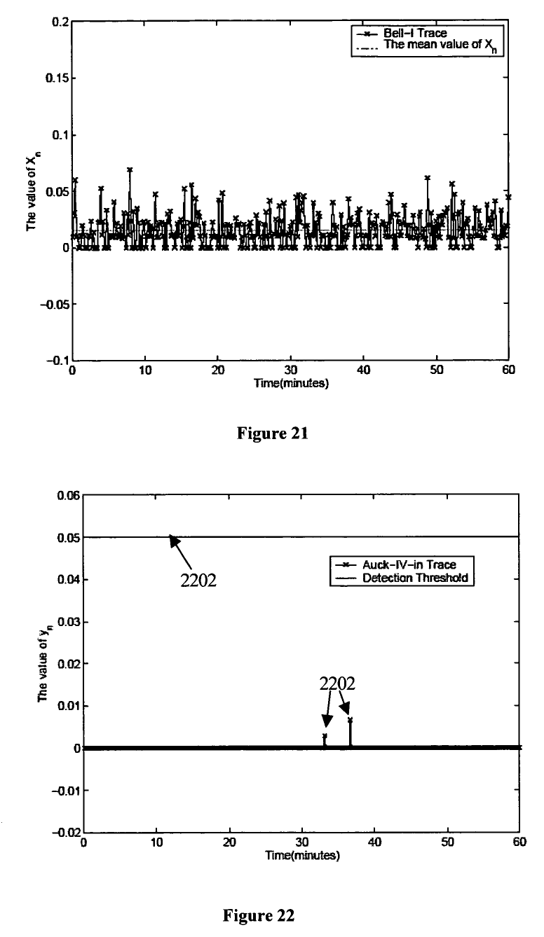

The traffic management system 300 was configured to detect the percentage of new IP addresses observed in each 10 second interval (Xn). FIGS. 19 to 21 shows the behavior of this parameter when applied to the three traces. The performance of variable Xn in the Auck-IV-out Trace (FIG. 20) is more stable than in the Auck-IV-in (FIG. 19) and Bell-I (FIG. 21) traces. The reason lies in the fact that the population of users within a local network, such as the University of Auckland, is more stable than the population of users who access that network from the Internet. Thus, there are very few IP addresses which are new to the address database 412. In contrast, the Bell-I data trace is bi-directional and contains the traffic from users outside the network, which results in its large variance. In the experiment, the Bell-I data trace was used as the background traffic for the last-mile router.

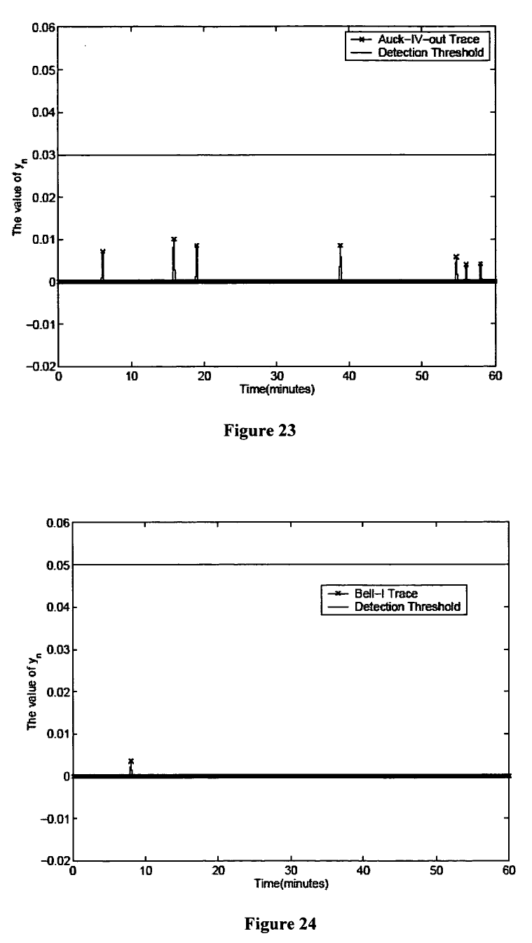

FIGS. 22 to 24 illustrates the corresponding CUSUM statistics {yₙ} derived by applying the detection process to the aforementioned three traces. The Auck-IV-out trace is used as an example to demonstrate how the {yₙ} are generated. The mean value of {Xₙ}, which is E{Xₙ}=α, is determined by the learning engine using traffic statistics before detection. For the Auck-IV-in trace, α=0.0205. Since the configuration here corresponds to the last-mile router, then |a|=0.05 and N=0.05, as described above. Thus, β=0.0705, and Zₙ=Xₙ−0.0705. yₙ are then determined by summing the Z_{N} values.

As shown in FIG. 22, yₙ is very stable, but includes some separated bursts caused by the bursty feature of the Internet traffic. However, the burst for the Internet traffic is normally very short, and thus does not produce a large accumulated value. These separated bursts are far below the threshold N=0.05, as shown by the line 2202 in FIG. 22, which provides a large safety margin. Therefore, the false alarm rate in this trace-driven experiment is reduced to zero. It is worth noting that α is updated periodically in order to ensure that it represents the most accurate estimation of the random sequence {Xₙ}.

DDoS Detection

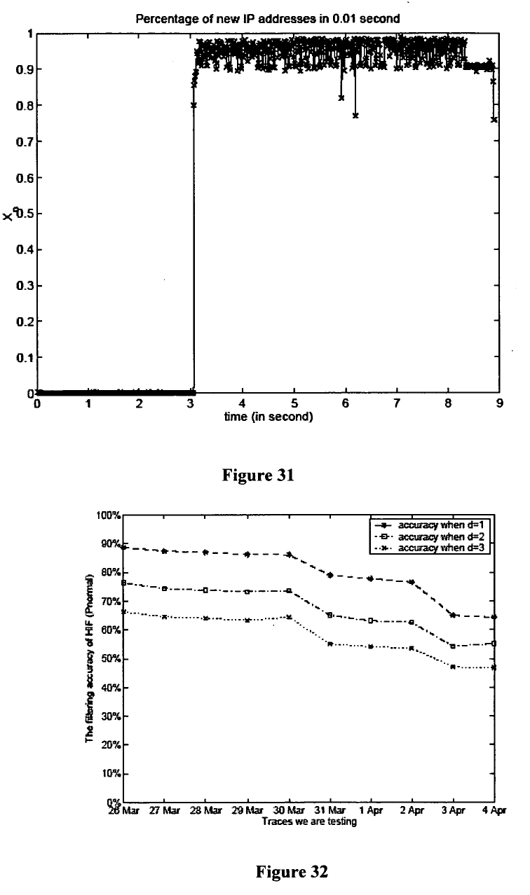

Randomly Spoofed DDoS attacks: The labelled DDoS attack scenario in the DARPA Intrusion Detection Data Set is used as an example to demonstrate the performance of the detection process. The DDoS attack observed here is a naive one which uses randomly spoofed IP addresses. The labelled attack started at time t=3 s and lasted for 5 seconds. Since the labelled attack is very short, the measurement interval was set to 0.01 seconds. As shown in FIG. 31, an abrupt change in the value of X_{N} at around 3 seconds represents the percentage of new IP addresses in a time slot of 0.01 second. Thus, the new address detection process easily detects DDoS attacks with randomly spoofed source IP addresses.

DDoS attacks with a small number of randomly spoofed IP addresses: In an attempt to avoid detection by the DDoS detection process, attackers could try to constrain the number of spoofed IP addresses that they use. Similarly, in the case of distributed reflector denial of service (DRDoS) attacks, the number of source IP addresses of the attack traffic depends on the number of reflectors. Thus, the attacker can control the number of new IP addresses used in the attack. However, there is a lower bound on the number of new IP addresses used, since the number of IP packets for a single IP address will increase with the decrease in the number of source IP addresses used. Therefore, this type of attack will be detected by the flow rate detection engine 402.

To test the detection sensitivity for DDoS attacks with different numbers of new IP addresses, the following experiment was conducted. The Auck-IV-in trace was used as the background traffic for the last-mile router detection evaluation, and Auck-IV-out trace was used as the background traffic for the first-mile router detection evaluation. As described above, the detection process is not affected by whether the attack traffic is bursty or constant since the detection is based on the cumulative effect of attack traffic. However, to simplify the experimental design, the attack traffic rate was assumed to be constant. The attack period was set to be 5 minutes, which is a commonly observed attack period in the Internet. The attack traffic rate for the last-mile router is set to be 500 Kbps in order to constitute an effective bandwidth attack to medium-size victim networks, which in this case is the network of the University of Auckland.

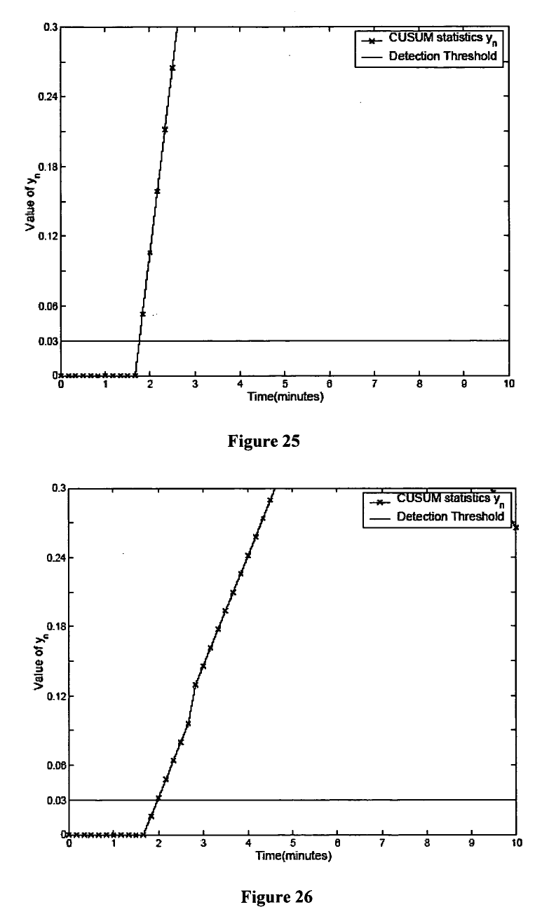

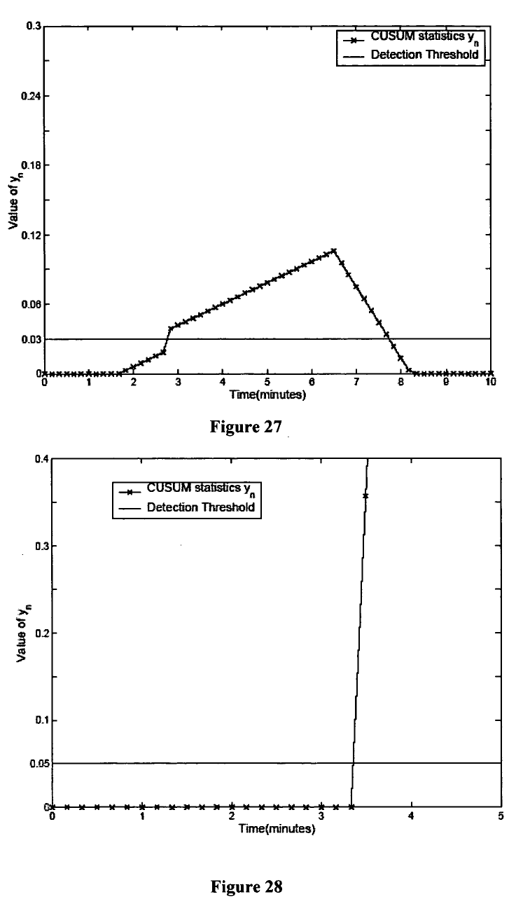

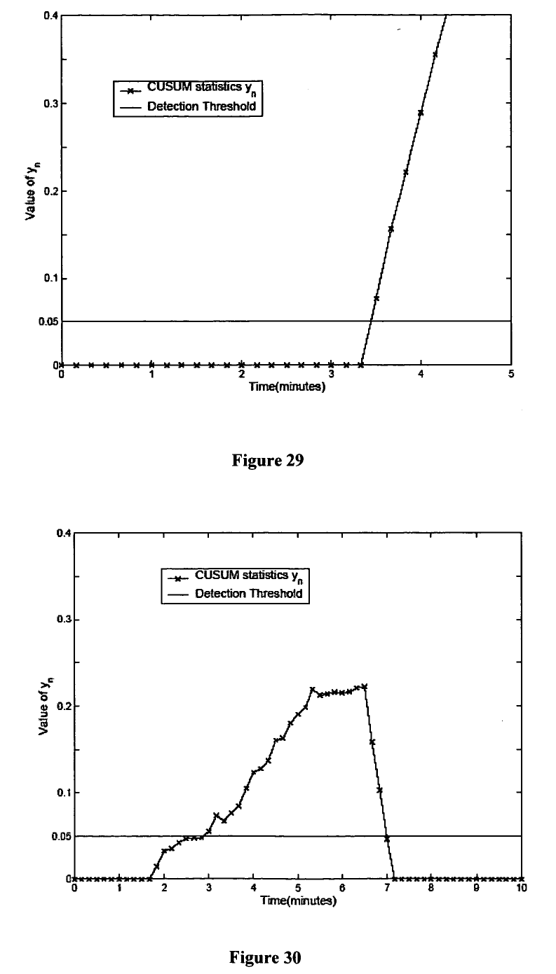

Let W represent the number IP addresses in the attack traffic which are new to the network. Different values of W were tested in the simulation, and the detection performance for the first and last-mile routers are shown in FIGS. 25 and 30, respectively. Attack detection was performed under a variety of different network conditions, and both the average detection accuracy and detection time are listed in Tables 3 and 4 below.

TABLE 3

| W | Detection Accuracy | Detection Time (seconds) |
|---|---|---|
| 2 | 99% | 69.7 |
| 4 | 100% | 20.1 |
| 6 | 100% | 18.9 |
| 8 | 100% | 10 |
| 10 | 100% | 10 |

TABLE 4

| W | Detection Accuracy | Detection Time (seconds) |
|---|---|---|
| 15 | 90% | 127.3 |
| 18 | 100% | 81.1 |
| 40 | 100% | 18.9 |
| 60 | 100% | 10 |
| 200 | 100% | 10 |

As can be seen from the simulation results, the detection process is very robust in both the first-mile and last-mile routers. For the last-mile router, the DDoS attack with W=18 was detected within 81.1 seconds with 100% accuracy, and the DDoS attack with W=15 was detected within 127.3 seconds with 90% accuracy. Given that the attack traffic length is no more than 5 minutes, only the attack traffic with W<18 has the possibility of sometimes avoiding detection. However, by forcing the attacker to use a small number of new IP addresses, the attack can be detected by observing the abrupt change of the number of packets per IP source address using the flow rate detection engine 402, as described above.

For the first-mile router, 99% detection accuracy can be achieved even when there are only two new IP address in the attack traffic. The reason lies in the fact that the background traffic for the first-mile router is very clear. Generally, there will be very few IP addresses that are new to the network because all the valid IP packets originated from within the same network. Since the IP addresses in the address database 412 will expire and be removed after a certain time period, the IP addresses within the subnetworks which have not been used recently will be new to the address database 412.

It is worth noting that the detection interval was chosen as Δn=10 s in the experiment, which is a conservative choice for a real implementation. If the detection interval was decreased by using more computing resources, the detection time can be reduced accordingly.

Filtering During a DDoS Attack

The performance of the history-based filtering process can be demonstrated by generating attacks in a testbed network. A simulation experiment was conducted by first training the system 300 using the University of Auckland data traces. Two attackers, Attacker 1 and Attacker 2 then launched DDoS attacks using the DDoS attack tool “Shaft”, while at the same time, normal traffic was sent to the Victim by reproducing the Auckland data traces.

The address database 412 and the detection and filtering tables were populated using the Auckland data traces from 12 Mar. 2001 to 25 Mar. 2001, and the DDoS attack tool “Shaft” was used to create DDoS attack traffic. For “Shaft”, the attack traffic uses random source IP addresses and random ports. A program was written to reproduce the real traffic sent to the University of Auckland as the background traffic, using the Auckland data traces from 26 Mar. 2001 to 9 Apr. 2001.

As shown in FIG. 32, when p₁(1) and p₂(3) are used to build the filtering table, the accuracy of the filtering process is close to 90% for traces in March, but drops to about 70% for traces in April. This is because the filtering table was generated using traces between March 12 and March 25, and therefore becomes less relevant for the traces in April. Significantly, it may be observed that the accuracy drops abruptly after March 31 while it behaves stably before that. This suggests that the filtering table should be updated at least every 5 days to achieve better performance. FIG. 32 shows that the accuracy of filtering is about 88%, 75% and 65% when using p₁(1), p₁(2) and p₁(3), with u=3.

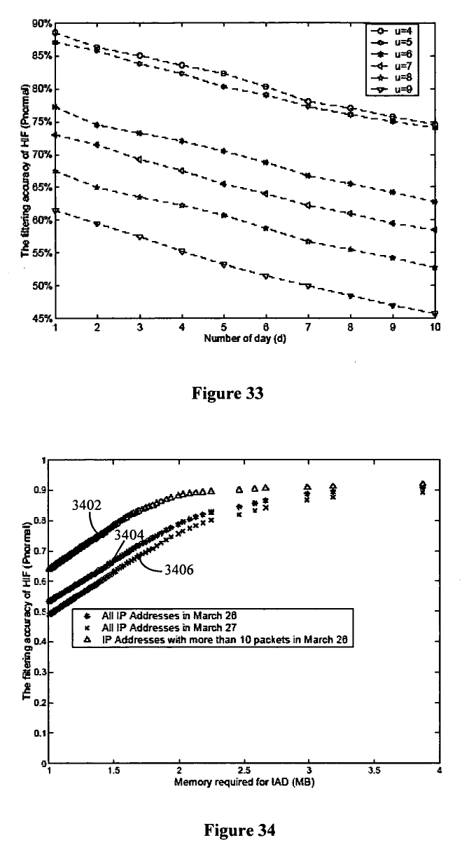

FIG. 33 shows how the filtering accuracy (Pₙₒᵣₘₐₗ) changes with d for several values of the parameter u. It may be observed that the performance of filtering when u=4 and u=5 are very close. This is because frequent IP addresses normally contain at least 5 packets, as discussed above. Thus when IP addresses containing 4 packets are removed from the filtering table to reduce memory requirements, the filtering accuracy is barely affected. With the sacrifice in accuracy, the memory requirement of the filtering table is reduced, as shown in FIG. 34. The data set 3402 at the top of the figure represents the percentage of IP addresses with more than 10 packets being protected. This shows that frequent IP addresses have a higher probability of being admitted. The middle data set 3404 performs better than the bottom curve because the filtering table was generated using traces between March 12 and March 25, which are more relevant to the packets in March 26. It may also be observed that the three curves 3402 to 3406 converge when the memory size of the filtering table is large. This means that all of the legitimate IP addresses that appeared before will have an equal chance of being accepted. Since randomly spoofed IP source addresses were used, the probability to accept a spoofed IP address is

$${P}_{ddos} = \frac{{p}_{1} ( d )}{{2}^{32}} .$$

Since p₁(d)≦373494 in the experiment, the false positive probability of accepting a spoofed IP packet is nearly zero.

If attackers know that the IP packet filter is based on previous network connections, they could deceive the system 300 in order to be included in the detection table. For example, they can first use a certain group of IP addresses to do some reconnaissance before the real attack. The attackers can control the reconnaissance traffic to be sufficiently low so as not to trigger the history-based filtering process. If the system 300 considers the reconnaissance traffic to be part of the normal traffic, it will add the attacker's reconnaissance IP addresses into the address database 412 and the detection table. Therefore, the attacker can use these IP addresses to launch a DDoS attack. Since these IP addresses appear in the detection table, the attack traffic can pass the filter easily, which constitutes a successful denial-of-service attack.

However, this can be prevented by increasing the period over which IP addresses appear in order to be considered frequent. Furthermore, an additional restriction can be applied to ensure that an IP address is only included in the address database 412 (and hence the detection and filtering tables) if a TCP connection using that address has successfully completed. This prevents the attacker from using spoofed IP addresses for which no host exists. The attacker can only launch their attack using the real IP address of their computer, which makes it much easier to identify and block the source of the attack. Moreover, the history-based IP filtering process can be combined with a probabilistic IP traceback process, as described in T. Peng, C. Leckie, and K. Ramamohanarao. Adjusted probabilistic packet marking for ip traceback, in Proceedings of Networking 2002, Pisa, Italy, May 2002. Thus, the history-based filtering process forces the attacker to use real IP source addresses so that they appear in the address database 412, and the traceback process then enables these source addresses to be traced back. Various methods can be used in order to identify IP addresses with unusual patterns of accesses, such as those described in C. Leckie and R. Kotagiri, A probabilistic approach to detecting network scans, in Proceedings of Eighth IEEE Network Operations and Management Symposium (NOMS 2002), Florence, Italy, 15-19 Apr. 2002.

It will be apparent that alternative rules for defining frequent IP addresses can be used to improve the accuracy of filtering. For example, the type of service accessed by the user and the length of each session can be used to identify frequent IP addresses.

The traffic management systems 300, 400 described above allow DDoS attacks to be detected with 100% accuracy when configured to detect as few as 18 new source IP addresses in the last-mile router and as few as 2 new IP address in the first-mile router. The detection process is fast and has a very low computing overhead. During an attack, the history-based filtering process can be used to protect 90% of legitimate traffic with only 4 MB of memory, and in another instance can protect 80% of legitimate traffic with only 800K of memory. The new address detection process produces a negligible number of false positive errors, when detecting DDoS attacks that use randomly spoofed source IP addresses.

Many modifications will be apparent to those skilled in the art without departing from the scope of the present invention as herein described with reference to the accompanying drawings.

1. A process for managing traffic in a communications network, including:
determining the source address of a received network packet; and
comparing said source address with stored source address data for network packets received in a previous time period.

2. A process as claimed in claim 1, wherein said step of determining includes determining the source addresses of a plurality of received network packets, and the process includes determining the number of new source addresses of said received network packets that are not included in said stored source address data.

3. A process as claimed in claim 2, including detecting a surge in network traffic on the basis of said number of new source addresses.

4. A process as claimed in claim 2, including detecting at least one of a distributed denial of service attack and a flash crowd event on the basis of the number of new source addresses.

5. A process as claimed in claim 2, wherein the numbers of new source addresses of received network packets are determined over successive time intervals, and the process includes detecting a surge in network traffic on the basis of the numbers of new source addresses over said successive time intervals.

6. A process as claimed in claim 5, including generating cumulative sums of said numbers of new source addresses, and wherein said step of detecting includes detecting a surge in network traffic on the basis of the cumulative sums.

7. A process as claimed in claim 5, including normalizing numbers of new source addresses; and generating cumulative sums of the normalized numbers of new source addresses, and wherein said step of detecting includes detecting a surge in network traffic is detected on the basis of the cumulative sums.

8. A process as claimed in claim 7, wherein the surge in network traffic is detected if a cumulative sum exceeds a predetermined value.

9. A process as claimed in claim 1, including blocking said received network packet if said stored source address data does not include data corresponding to said source address.

10. A process as claimed in claim 1, including determining whether to block said received network packet on the basis of stored address data corresponding to a source address of said packet.

11. A process as claimed in claim 10, wherein said determining includes determining whether to block said received network packet on the basis of the number of previously received packets including said source address.

12. A process as claimed in claim 10, including determining whether to reject said received network packet on the basis of a fraction of said previous time period in which packets having said source address were received.

13. A process as claimed in claim 12, including determining whether to reject said received network packet on the basis of the number of days that packets having said source address were received in said previous time period.

14. A process as claimed in claim 12, including:
selecting legitimate network packets from received network packets;
generating source address data from said legitimate network packets; and
storing the generated source address data with said stored source address data.

15. A process as claimed in claim 14, wherein the source address data for each source address includes a number of received packets with said source address, and a timestamp of said received packets.

16. A process as claimed in claim 12, including issuing a challenge to a source address of a received network packet, and determining whether said network packet is legitimate on the basis of a received response to said challenge.

17. A process as claimed in claim 12, including determining whether said network packet is legitimate on the basis of a number of received packets with said source address.

18. A process as claimed in claim 2, including:
determining, for each of said source addresses, a packet count representing the number of received network packets including the source address; and
detecting a surge in network traffic on the basis of said number of new source addresses and the number of said packet counts that exceed a predetermined value.

19. A process for managing traffic in a communications network, including:
determining the source addresses of received network packets;
comparing said source address with stored source address data for network packets received in a previous time period to determine a number of new source addresses; and
detecting a surge in network traffic on the basis of the number of new source addresses.

20. A process as claimed in claim 19, including filtering each of said received network packets on the basis of previously received network packets including the source address of the packet.

21. A process for detecting anomalous traffic in a communications network, including:
determining source addresses of received network packets;
comparing said source addresses with stored source address data for network packets received in a previous time period to determine the number of new source addresses for which data is not included in said stored source address data; and
detecting at least one of a distributed denial of service attack and a flash crowd event on the basis of the number of new source addresses.

22. A filtering process, including:
determining the source address of a received network packet;
determining at least one of the number of packets with said source address received in a previous time period and a fraction of said previous time period in which packets with said source address were received; and
determining whether to block said received network packet on the basis of at least one of said number and said fraction.

23. A system having components for executing the steps of any one of claims 1 to 22.

24. A computer readable storage medium having stored thereon program code for executing the steps of any one of claims 1 to 22.

25. A traffic management system for use in a communications network, including:
a source address detection module for determining the source addresses of received network packets; and
a decision module for detecting a surge in network traffic on the basis of a comparison of said source addresses with stored source address data for network packets received in a previous time period.

26. A traffic management system as claimed in claim 25, including a flow rate module for determining the flow rates of received packets including each of said source address; and wherein said decision module is adapted to detect a surge in network traffic on the basis of said flow rates and a comparison of said source addresses with stored source address data for network packets received in a previous time period.

27. A traffic management system as claimed in claim 25, including a learning module for performing one or more legitimacy tests on received network packets to determine whether to stored data for the received network packets with said stored source address data.

28. A traffic management system as claimed in claim 27, wherein said learning module is adapted to issue a challenge to a source address of a received network packet, and to determine whether said network packet is legitimate on the basis of a received response to said challenge.
